(19) United States
(12) Patent Application Publication
(10) Pub. No.: US 2024/0370256 A1
(43) Pub. Date: Nov. 7, 2024

(54) APPLICATION MIGRATION METHOD FROM CLIENT-SERVER ARCHITECTURE TO BLOCKCHAIN ARCHITECTURE

(71) Applicant: FUZHOU UNIVERSITY, Fuzhou (CN)

(72) Inventors: Xing CHEN, Fuzhou (CN); Liqiang LIN, Fuzhou (CN); Hanlin CHEN, Fuzhou (CN)

(73) Assignee: FUZHOU UNIVERSITY, Fuzhou (CN)

(21) Appl. No.: 18/739,408

(22) Filed: Jun. 11, 2024

Related U.S. Application Data
(63) Continuation of application No. PCT/CN2023/097419, filed on May 31, 2023.

(30) Foreign Application Priority Data
Apr. 7, 2023 (CN) 202310366690.1

(51) Int. Cl. G06F 8/72; G06F 8/75

(52) U.S. Cl. CPC G06F 8/72; G06F 8/75

(57) ABSTRACT

An application migration method from client-server architecture to blockchain architecture is provided. The application migration method includes the following steps: S1: modeling an application program of a conventional client-server architecture and abstracting the application program to a program call tree; S2: defining a taint propagation rule for taint analysis by taking key data as tainted data, to acquire all taint variables in the application program; and S3: identifying a key module of the application program on the program call tree according to a tainted path, and setting a code refactoring rule to perform code refactoring on a method in the key module according to a special program structure.

### CROSS-REFERENCE TO THE RELATED APPLICATIONS

This application is a continuation application of International Application No. PCT/CN2023/097419, filed on May 31, 2023, which is based upon and claims priority to Chinese Patent Application No. 202310366690.1, filed on Apr. 7, 2023, the entire contents of which are incorporated herein by reference.

### TECHNICAL FIELD

The present invention relates to the technical field of blockchain, and particularly relates to an application migration method from client-server architecture to blockchain architecture.

### BACKGROUND

With rapid development of the blockchain technology, many organizations now try a blockchain solution. In this newborn stage, due to scarcity of experts in the field of blockchain, a tendency of converting a legacy system automatically into a system based on blockchain is increasingly large. However, it is a challenge to transition from the prior art to the blockchain technology. In the industry, the blockchain solution is only developed started from scratch or a database terminal of an original application is only transformed. The former needs a lot of time and money with a huge cost, and the latter cannot be guaranteed in safety.

### SUMMARY

In view of this, an object of the present invention is to provide an application migration method from client-server architecture to blockchain architecture, which can effectively improve the development efficiency of the blockchain application.

To achieve the above object, the present invention adopts the following technical solution: an application migration method from client-server architecture to blockchain architecture includes the following steps: S1: modeling an application program of a conventional client-server architecture and abstracting the application program to a program call tree; S2: defining a taint propagation rule for taint analysis by taking key data as tainted data, to acquire all taint variables in the application program; and S3: identifying a key module of the application program on the program call tree according to a tainted path, and setting a code refactoring rule to perform code refactoring on a method in the key module according to a special program structure.

In a preferred embodiment, the S1 specifically includes: establishing the program call tree, constructing the program call tree of the application program from the main function through static code analysis, and marking the key data on the program call tree; and definitions of the program call tree are as follows:
Definition 1: the program structure of an application program of client-server architecture is represented as a program call tree Treeᵣ=(M, R, K), where M={m₁, m₂, . . . , mₙ} represents a node set of the program call tree; R represents a node call relationship set, any one rₘᵢ₋ₘⱼ∈R represents a side of the program call tree, representing that a method mᵢ calls a method mⱼ and K={keydata₁, keydata₂, . . . , keydataₙ}represents a key data set in a system;
definition 2: a method node of a program call tree includes a unique identifier and a call path of the method, a statement set of the method and a set of the key data in the method, and mᵢ=<mSignᵢ, mPath, Uᵢ, kset> is represented by a quaternion, where mSign represents the unique identifier of the method mᵢ, mPath represents a method call path from the main function to mᵢ, kset is used to record all key data in the method mᵢ, and Uᵢ, represents the statement set of the method mᵢ;
definition 3: mSignᵢ={mSig|mName,mParams,returnParams} represents the unique identifier of a method node of a program call tree, where mName represents a method name, mParams represents an entry parameter list of the method, and returnParams represents return parameters of the method;
definition 4: mPath={mSigₘₐᵢₙ,mSigₐ, . . . , mSigᵢ} represents the call path of a program call tree method mᵢ, a combination of the unique identifiers of the method node from mₘₐᵢₙ to mᵢ, uniquely forming a path accessible to mᵢ;
definition 5: Uᵢ={uᵢ¹, uᵢ², . . . , uᵢⁿ} represents the statement set of the method node mᵢ on the program call tree, where uᵢ^{j} represents the j^{th} statement of the method mᵢ; and
definition 6: the key data of a system includes the unique identifier of the key data in the method and a key data name, and eydataᵢ={mSignᵢ, kname} is represented by a two-tuple, where kname represents a variable in the method mᵢ with a name of kname, and variables on a data flow branch where all key data is located may be key variables.

In a preferred embodiment, an algorithm extracted by the program call tree constructs a program call tree of an application taking mₘₐᵢₙ as a root by taking the main function mₘₐᵢₙ as an entry point of the application, a HashMap is used to record a R, a storage form of key is <mᵢ, mⱼ>, formula represents that mᵢ calls mⱼ and a value corresponding thereto represents a number of times when mᵢ calls mⱼ for the entry point mₘₐᵢₙ of the input program of the algorithm and the statement set Uₘₐᵢₙ of mₘₐᵢₙ, any uₘₐᵢₙⁱ∈Uₘₐᵢₙ represents the i^{th} statement of Uₘₐᵢₙ; the program call tree is constructed recursively by calling a method getTree( ), where parameters mₐ and Uₐ are written into the method, respectively representing a method to be analyzed and the statement set of the method; where a Soot key word of uₐⁱ is acquired, i.e., an intermediate code defined in Soot; a set M is updated to record that the method ma calls the method mₛ; a set R is updated to record a method call relationship and update a weight; the method mₛ is subjected to getTree( ) recursion; and when the recursion process is ended, the algorithm outputs the program call tree.

In a preferred embodiment, the assignment statement rule and the alias statement rule in the taint propagation rule in the S2 summarize the various ways of the taint variables propagation in a method; a method call statement rule, a method return statement rule and a method declaration statement rule describe cross-method propagation modes of the taint variables; first, for each method node containing the key data, each statement in the method is analyzed according to the taint propagation rule, and when the statement meets any taint propagation rule, it is indicated that a new taint source is found, and the new taint source is added into a taint source set for recording; wherein when the statement meets the method call statement rule, the method return statement rule or the method declaration statement rule, it is indicated that a new method node to be analyzed is generated, and the method node needs to be added into a set of the method node to be analyzed for recording; after a round of analysis of all statements of the method is ended, if the new taint source is added into the taint source set, a new round of iteration is started to analyze the method; and finally, the set of the method node to be analyzed is traversed to analyze each method node in the set one by one.

In a preferred embodiment, the S3 includes key module identification, program structure and method wrapper generation, method proxy construction and Java Data Base Connectivity (JDBC) refactoring.

In a preferred embodiment, the step of key module identification specifically includes: when a kset set of a method node m_{cur} is non-empty and a kset set of a father method node thereof is empty, taking a sub-tree with m_{cur} as a root node a key code module of the application, where the key code module is specifically defined as follows:

definition 7: the key code module of the application program is represented as Module=(module₁, module₂ . . . moduleₙ), Module∈ Treeᵣ, where moduleᵢ is a sub-tree of Treeₘₐᵢₙ, representing a key code mode of the application program and being represented as moduleᵢ=<M,R>(if i≠j, moduleᵢ∩moduleⱼ=Ø); identifying the key module: first, adding the root node mₐ into a queue of the method node to be analyzed by taking the program call tree as an input and the root node mₐ of the program call tree as an entry; when the queue is not empty, acquiring the method node in the queue, if a taint source of the node method is non-empty, indicating that a key module is found, and all subsequent nodes all are method nodes in the key module; if the taint source of the node method is empty, acquiring all sub-nodes thereof and adding the sub-nodes into a queue of the nodes to be analyzed; and finally, when the set is empty, ending the algorithm.

In a preferred embodiment, structures and calling processes of a native application and a target application are described first;

a core of a target program structure includes two elements: a method wrapper Method_T_Wrapper and a method proxy Method_T_Proxy, where an operating principle of the target program structure is as follows: direct call of Method_T by Method_I is converted into indirect call via the Method_T_Proxy; the Method_T_Wrapper completes the function as same as the Method_T, is responsible for executing true computation, transforms the Method_T, finds out external variable references thereof, and transforms the method into a form being introduced through parameters and returned through returned values, and the modified class method is stateless; the Method_T_Proxy is a proxy of the method Method_T, and external behaviors thereof are consistent with those of the Method_T, and the proxy does not perform actual computation, is responsible for determining an execution position of the method, and perform controlled forwarding and data synchronism.

In a preferred embodiment, the method wrapper is generated by the following steps:
(1) modifying the parameter list and the returned values of the method; increasing the parameters params, representing the external variables of the original method, wherein the external variables are introduced into a method body in a form of parameters; increasing the statements to assign the parameters params to global variables global_params, wherein all methods in the key module are capable to call external variables of the methods; and moreover, adding the global_params into a returned result, and being capable to return a change condition of the external variables to a method caller;
(2) modifying all statements access to the external variables in the method, replacing the external variable references c and d with corresponding input parameters global_params.c and global_params.d, where there are no statements access to the external variables in the method; and
(3) modifying all return statements of the method, adding the parameters global_params into the returned result, wherein the change condition of the external variables can be returned to the method caller.

In a preferred embodiment, a construction rule for the method proxy is as follows:
(1) keeping a method signature and a return type of the method proxy consistent with those of the original method;
(2) increasing the statements for processing extra variables; constructing a variable params of a Params type, and assigning the params with external variable information of the method;
(3) increasing the statements to call the method wrapper in a fabric chain code; in a Hyperledger Fabric, calling the method wrapper Method_T_Wrapper in the chain code through a fabricManager object provided by sdk, and moreover, sending call parameters of the method wrapper; and
(4) increasing the returned results called by a statement receiving method, wherein the external variables of the method are updated by using result data to guarantee the consistency of the program state, and moreover, returning a method call returned value to the caller thereof.

In a preferred embodiment, the application for JDBC refactoring uses a relationship database, a relationship table structure needs to be defined first for use of the application, and then related business codes of the application edited through JDBC API; a database operating node is an SQL statement in the node, a function of the database is operated through the JDBC API, and the statement is usually a landing point or a start point of the key data in the propagation path; the JDBC API is converted into a key value of a corresponding blockchain to operate API for the database, where a current mainstream open source blockchain architecture Fabric chaincode is targeted; and the Fabric chaincode uses a Couch DB key value database, and a refactoring method includes analysis and verification of the SQL statement and operational conversion from the SQL statement to CouchDB.

Compared with the prior art, the present invention has the following beneficial effect: the present invention provides an adaptive migration framework to promote the existing client-server architecture application to be migrated to the application based on the blockchain. First, the method includes the following steps: establishing the program call tree, constructing a program call tree of the whole application program from the main function through static code analysis, and marking the key data on the call tree; then, defining the taint propagation rule for taint analysis by taking key data as tainted data, to acquire all taint variables in an application program; and finally, identifying the key module of the application program on the program call tree in combination with the tainted path, and setting the code refactoring rule to perform code refactoring on the method in the key module according to the special program structure. The method is evaluated by way of exemplary studies, and experimental results show that the method can effectively improve the development efficiency of the blockchain application.

### BRIEF DESCRIPTION OF THE DRAWINGS

FIGS. 1A-1B show a schematic diagram where structures and calling processes of a native application and a target application are described according to a preferred embodiment of the present invention, where FIG. 1A is a source program structure, and FIG. 1B is a target program structure;

FIGS. 2A-2B show a schematic diagram of generating steps of the method wrapper in the preferred embodiment of the present invention, where FIG. 2A is the source program, and FIG. 2B is the method wrapper; and

FIGS. 3A-3B show a schematic diagram of a construction rule of a method proxy in the preferred embodiment of the present invention, where FIG. 3A is the source program, and FIG. 3B is the method proxy.

### DETAILED DESCRIPTION OF THE EMBODIMENTS

Further description of the present invention will be made below in combination with drawings and embodiments.

It is to be noted that the detailed description below is exemplary and is intended to further describe the application. Unless specified otherwise, all technical and scientific terms used herein have the same meaning as commonly understood by those of ordinary skill in the art to which the application belongs.

It is to be noted that the terms used herein are merely used for describing specific embodiments, and are not intended to limit the exemplary embodiments according to the present application; as used herein, unless otherwise specified in the context, the singular form is further intended to include plural form. In addition, it is to be further understood that when the terms “comprise” and/or “include” are used in the description, it indicates that there are features, steps, operations, apparatuses, assemblies and/or their combinations.

An application migration method from client-server architecture to blockchain architecture includes the following steps: S1: modeling an application program of a conventional client-server architecture and abstracting the application program to a program call tree; S2: defining a taint propagation rule for taint analysis by taking key data as tainted data, to acquire all taint variables in the application program; and S3: identifying a key module of the application program on the program call tree according to a tainted path, and setting a code refactoring rule to perform code refactoring on a method in the key module according to a special program structure.

The step 1 specifically includes: establishing the program call tree, constructing the program call tree of the application program from the main function through static code analysis, and marking the key data on the program call tree; and definitions of the program call tree are as follows:
definition 1: the program structure of an application program of client-server architecture is represented as a program call tree Treeᵣ(M, R, K), where M={m₁, m₂, . . . , mₙ} represents a node set of the program call tree; R represents a node call relationship set, any one rₘᵢ₋ₘⱼ∈R represents a side of the program call tree, representing that a method mᵢ calls a method mⱼ and K={keydata₁, keydata₂, . . . , keydataₙ} represents a key data set in a system;
definition 2: a method node of a program call tree includes a unique identifier and a call path of the method, a statement set of the method and a set of the key data in the method, and mᵢ=<mSignᵢ, mPath, Uᵢ, kset> is represented by a quaternion, where mSign represents the unique identifier of the method mᵢ, mPath represents a method call path from the main function to mᵢ, kset is used to record all key data in the method mᵢ, and Uᵢ, represents the statement set of the method mᵢ;
definition 3: mSignᵢ={mSig|mName,mParams,returnParams} represents the unique identifier of a method node of a program call tree; where mName represents a method name, mParams represents an entry parameter list of the method, and returnParams represents returned parameters of the method;
definition 4: mPath={mSigₘₐᵢₙ,mSigₐ, . . . , mSigᵢ} represents the call path of a program call tree method mᵢ, a combination of the unique identifiers of the method node from mₘₐᵢₙ to mᵢ, uniquely forming a path accessible to mᵢ;
definition 5: Uᵢ={uᵢ¹, uᵢ², . . . , uᵢⁿ} represents the statement set of the method node mᵢ on the program call tree, where uᵢ^{j} represents the j^{th} statement of the method mᵢ; and
definition 6: the key data of a system includes the unique identifier of the key data in the method and a key data name, and eydataᵢ={mSignᵢ, kname} is represented by a two-tuple, where kname represents a variable in the method mᵢ with a name of kname, and variables on a data flow branch where all key data is located may be key variables.

The program call tree extraction algorithm is shown as follows:

Program call tree extraction algorithm

```
Input:
  A mₘₐᵢₙ method whose statements are Uₘₐᵢₙ={uₘₐᵢₙ¹ ,uₘₐᵢₙ² ,...,uₘₐᵢₙ³ }
Output:
  A program call tree Treeₘₐᵢₙ=(M, R)
Declare:
```

| | getMethod(uₓⁱ): A method which gets signature of a method from uₓⁱ |
|---|---|
| | getUnits(signature): A method which gets statement of a method according to its signature |
| 1. | M←M + mₘₐᵢₙ, R←Ø |
| 2. | function getTree(mₐ, Uₐ) |
| 3. | for each uₐⁱ ∈ Uₐ do |
| 4. | keywords←Soot(uₐⁱ) |
| 5. | if ∃“invoke” ∈ keywords then |
| 6. | mSig←getMethod(uₐⁱ) |
| 7. | cSeq←mₐ.cSeq + mSig |
| 8. | mₛ←<mSig,cSeq> |
| 9. | Uₛ←getUnits(mSig) |
| 10. | M←M + mₛ |
| 11. | if<mₐ,mₛ> ∈ R.key then |
| 12. | ++rₘₐ₋ₘₛ |
| 13. | else |
| 14. | rₘₐ₋ₘₛ←1 |
| 15. | R←R + rₘₐ₋ₘₛ |
| 16. | end if |
| 17. | getTree(mₛ,Uₛ) |
| 18. | end if |
| 19. | end for |
| 20. | end function |

The algorithm describes the extraction process of the program call tree. The algorithm constructs a program call tree of an application taking mₘₐᵢₙ as a root by taking the main function mₘₐᵢₙ as an entry point of the application, a HashMap is used to record a R, a storage form of key is <mᵢ, mⱼ>, formula represents that mᵢ calls mⱼ and a value corresponding thereto represents a number of times when mᵢ calls mⱼ. For the entry point mₘₐᵢₙ of the input program of the algorithm and the statement set Uₘₐᵢₙ of mₘₐᵢₙ, any uₘₐᵢₙⁱ∈Uₘₐᵢₙ represents the i^{th} statement of Uₘₐᵢₙ. The program call tree is constructed recursively in lines 2-20 by calling a method getTree( ), where parameters mₐ and Uₐ are written into the method, respectively representing a method to be analyzed and the statement set of the method. A Soot key word of uₐⁱ is acquired in the 4th line, i.e., an intermediate code defined in Soot, for example, an invoke keyword represents that this is a method call statement, and an intact keyword definition can refer to a Soot manual. If the statement contains the keyword called by the method, a set M is updated in lines 6-10 to record that the method mₐ calls the method mₛ. A set R is updated in lines 11-16 to record a method call relationship and update a weight. The method mₛ is subjected to getTree( ) recursion in the 17^{th} line. When the recursion process is ended, the algorithm outputs the program call tree.

| | | Description | |
|---|---|---|---|
| | | (a is the key | |
| | | data or taint | |
| Statement | | source, and b | |
| type | Rule | is the variable) | Conclusion |
| Alias | (1) b = a | a is the object | b is the taint source |
| | | reference | |
| Assign | (2) a = b | a is the basic | b is the taint source |
| statement | | data type | |
| | (3) a = b | a is the object | b is the taint source |
| | | reference | |
| | (4) a.f = b | f is a data member | b is the taint source |
| | | of the object a | |
| | (5) a = b.f | b is the object | b is the taint source |
| | | reference | |
| | (6) a = €(v₁, | € is a | v₁, v₂ . . . vₙ |
| | v₂ . . . vₙ) | multivariate | are the taint |
| | | operator | |
| Method | (8) Object | a is the object | An actual parameter |
| declaration | function(Object a, | reference | corresponding to a |
| statement | Object obj2 . . .) | | formal parameter a |
| | | | of the function method |
| | | | is the taint source |
| Method call | (9) function(para1 = a, | a is the object | Paral in the function |
| statement | para2 = b . . .) | reference, function | method is the taint source |
| | | is not Java API | |
| Method return | (10) a = function(b) | function() is not | The returned value called |
| statement | | Java API | by this function method |
| | | | is the taint source |
| | a = b.function(c) | function() is not | The returned value called |
| | | Java API | by this function method |
| | | | is the taint source |
| SQL statement | a = “select filed | a is the object | a, v₁, v₂ . . . vₙ |
| | from table where . . . | reference | are the taint sources, |
| | ” + v1 + v2 . . . + vn | | table is the key table |
| | a = “insert into | a is the object | a, v₁, v₂ . . . vₙ |
| | table(filed1, filed2 . . .) | reference | are the taint sources, |
| | values(val1, val2 . . .) | | table is the key table |
| | ” + v1 + v2 . . . + vn | | |
| | a = “update table set | a is the object | a, v₁, v₂ . . . vₙ |
| | field₁ = val₁, field₂ = | reference | are the taint sources, |
| | val₂, . . .” + v₁ + v₂ . . . + vₙ | | table is the key table |
| | a = “delete from table | a is the object | a, v₁, v₂ . . . vₙ |
| | where . . .” + v1 + v2 . . . + vn | reference the | are the taint sources, |
| | | key table) | table is the key table |

| | | Description | |
|---|---|---|---|
| Statement | | (table is | |
| type | Rule | the key table) | Conclusion |
| SQL statement | a = “select filed from table | a is the object | a, v₁, v₂ . . . vₙ |
| | where . . .” + v1 + v2 ... + vn | reference | are the taint sources |
| | a = “insert into table(filed1, | a is the object | a, v₁, v₂ . . . vₙ |
| | filed2 . . .) values(val1, val2 . . .)” + v1 + v2 . . . + vn | reference | are the taint sources |
| | a = “update table set field₁ = val₁, | a is the object | a, v₁, v₂ . . . vₙ |
| | field₂ = val₂, . . .” + v₁ + v₂ ... + vₙ | reference | are the taint sources |
| | a = “delete from table | a is the object | a, v₁, v₂ . . . vₙ |
| | where . . .” + v1 + v2 . . . + vn | reference | are the taint sources |

The above table exhibits the taint propagation rule defined, where the assignment statement rule and the alias statement rule induce various modes of propagation of taint variables in a method; the method call statement rule, the method return statement rule and the method statement rule describe the propagation mode of a taint variable cross-method; the sql rule induces a situation that the taint variables are finally gathered in a database table, and in this case, the table is the key table, so that a situation that the key table is operated to introduce a new taint variable is complementarily induced.

To find out all the taint sources, it is needed to analyze each statement in the program according to the taint propagation rule. First, for each method node containing the key data, each statement in the method is analyzed according to the taint propagation rule. When the statement meets any taint propagation rule, it indicates that a new taint source is found, and the new taint source is added into a taint source set of the method for recording. When the statement meets the method call statement rule, the method return statement rule or the method statement rule, it indicates that a new method node to be analyzed is generated, and it is needed to add the method node into the set of the method node to be analyzed for recording. After a round of analysis of all statements of the method is ended, if the new taint source is added into the taint source set of the method, a new round of iteration is started to analyze the method. Finally, the set of the method node to be analyzed is traversed to analyze each method node in the set one by one. The taint propagation analysis algorithm is shown as follows:

Taint propagation analysis algorithm

Input: the method node set containing the key data M_{K}, the program call tree Treeₘₐᵢₙ=(M,R,K)
Output: the program call tree recording all taint sources
Description: N_Set records the method node to be analyzed, T_Set records the processed data
table, and temp_Set records the data table to be analyzed.

taint_source represents a taint source, and get_parents_method(m) acquires a father

node of the method node m on the program call tree.

| | |
|---|---|
| 1. | initialize N_Set, T_Set |
| 2. | function taint_analysis( ) |
| 3. | while !M_{K}.isEmpty( ) do |
| 4. | N_Set.add(M_{K}) |
| 5. | M_{K}.clear( ) |
| 6. | while !N_Set.isEmpty( ) do |
| 7. | m=N_Set.pop( ) |
| 8. | method_analysis(m) |
| 9. | end while |
| 10. | temp_Set= temp_Set- temp_Set∩T_Set |
| 11. | if !temp_Set.isEmpty( ) do // |
| 12. | for each mi in M do |
| 13. | method_analysis2(mi) |
| 14. | end for |
| 15. | end if |
| 16. | T_Set.add(temp_Set) |
| 17. | temp_Set.clear( ) |
| 18. | end while |
| 19. | end function |
| 20. | function method_analysis(m) |
| 21. | old_count = m.kset.size( ) //record the number of the taint sources in the taint source set |
| | before method analysis |
| 22. | for each u in Uₘ do //analyze each statement in the method m one by one |
| 23. | switch get_stmt_rule(u) |
| 24. | case assign_stmt //assign the statement rule |
| 25. | taint_source=get_ assign _source(u) //acquire the new taint source |
| 26. | if !m.kset.contains(taint_source) |
| 27. | m.kset.add(taint_source) //add the new taint source in the set |
| 28. | end if |
| 29. | break |
| 30. | case assign_stmt //alias statement rule |
| 31. | taint_source=get_alias_source(u) |
| 32. | if !m.kset.contains(taint_source) |
| 33. | m.kset.add(taint_source) |
| 34. | end if |
| 35. | break |
| 36. | case invoke_stmt //method call statement rule |
| 37. | mₛ= get_method(u) //acquire the call method in the statement |
| 38. | taint_source=get_invoke_source(u) |
| 39. | if !mₛ.kset.contains(taint_source) |
| 40. | N_Set.add(mₛ) |
| 41. | mₛ.kset.add(taint_source) |
| 42. | end if |
| 43. | break |
| 44. | case return_stmt //method return statement rule |
| 45. | mₛ= get_method(u) |
| 46. | taint_source=get_ return _source(u) |
| 47. | if !mₛ.kset.contains(taint_source) |
| 48. | N_Set.add(mₛ) |
| 49. | mₛ.kset.add(taint_source) |
| 50. | end if |
| 51. | break |
| 52. | case declar_stmt //method declaration statement rule |
| 53. | mₛ= get_parents_method(m) |
| 54. | taint_source=get_declar_source(u) |
| 55. | if !mₛ.kset.contains(taint_source) |
| 56. | N_Set.add(mₛ) |
| 57. | mₛ.kset.add(taint_source) |
| 58. | end if |
| 59. | break |
| 60. | case assign_stmt //sql statement rule |
| 61. | table=regex_get_sql(u) //acquire the data table in the sql statement |
| 62. | if !temp.set.contains(table) && !T_Set.contains(table) do |
| 63. | temp_Set.add(table) |
| 64. | end if |
| 65. | taint_source=get_sql_source(u) |
| 66. | if !m.kset.contains(taint_source) |
| 67. | m.kset.add(taint_source) |
| 68. | end if |
| 69. | break |
| 70. | end switch |
| 71. | end for |
| 72. | now_count= m.kset.size( ) |
| 73. | if now_count > old_count //iteratively analyze the method if the new taint source is |
| | generated |
| 74. | method_analysis(m) |
| 75. | end if |
| 76. | end funciton |
| 77. | function method_analysis2(m) |
| 78. | for each u in Uₘ do |
| 79. | switch get_stmt_rule(u) |
| 80. | case assign_stmt //sql query statement |
| 81. | m.type= ”jdbc_query” |
| 82. | break |
| 83. | case assign_stmt //sql insert statement |
| 84. | taint_source=get_ sql_insert _source(u) |
| 85. | if !m.kset.contains(taint_source) |
| 86. | m.kset.add(taint_source) |
| 87. | Mk.add(m) |
| 88. | end if |
| 89. | break |
| 90. | case assign_stmt //sql alter statement |
| 91. | taint_source=get_declar_source(u) |
| 92. | if !m.kset.contains(taint_source) |
| 93. | m.kset.add(taint_source) |
| 94. | Mk.add(m) |
| 95. | end if |
| 96. | break |
| 97. | case assign_stmt //sql delete statement |
| 98. | taint_source=get_declar_source(u) |
| 99. | if !m.kset.contains(taint_source) |
| 100. | m.kset.add(taint_source) |
| 101. | Mk.add(m) |
| 102. | end if |
| 103. | break |
| 104. | end switch |
| 105. | end for |
| 106. | end function |

### Step 3:

### 3.1 Key Module Identification

The key code module is the target objective which achieves adaptive migration from client-server architecture to blockchain architecture, which is an explanation of the key data calling the key code module in the program call tree: when a kset set of a method node m_{cur} is non-empty and a kset set of a father method node thereof is empty, a sub-tree with m_{cur} as a root node is taken as a key code module of the application. A specific definition of the key code module is as follows:
definition 7: the key code module of the application program is represented as Module=(module₁, module₂ . . . moduleₙ), Module∈ Treeᵣ. moduleᵢ is a sub-tree of the Treeₘₐᵢₙ, representing a key code module of the application program, which can be represented as moduleᵢ=<M,R>(if i≠j, moduleᵢ∩moduleⱼ=Ø).

### Key Module Partitioning Algorithm

| | |
|---|---|
| Input: | Program call tree Treeₘₐᵢₙ=(M,R,K) |
| Output: | Key module set P |

| | |
|---|---|
| Description: | queue records the method node to be analyzed |

get_parent_method( ) acquires the father method node of the method node according to the
program call tree
get_child_method( ) acquires the child method node of the method node according to the program
call tree

| | |
|---|---|
| 1. | function get_key_path( ) |

| | |
|---|---|
| 2. | initialize queue |
| 3. | queue.add(mₐ) //add the root node into the node set to be analyzed |
| 4. | while !queue.isEmpty( ) do |

| 5. | m=queue.poll( ) | |
|---|---|---|
| 6. | if !m.kset.isEmpty( ) then | //when the taint source of the method node m is not empty |
| 7. | mpost=get_post(m) | //acquire the sub-tree with the method node m as the root |
| 8. | P.add(mpost) | |
| 9. | else | |
| 10. | mpost=get_post(m) | //acquire the sub node set of the method node m |

| | |
|---|---|
| 11. | for each m_{child} in Mchildren |
| 12. | queue.add(m_{chita}) |
| 13. | end for |
| 14. | end if |

| | |
|---|---|
| 15. | end while |

| | |
|---|---|
| 16. | end function |

The key module is identified, where first, the root node mₐ is added into a queue of the method node to be analyzed by taking the program call tree as an input and the root node mₐ of the program call tree as an entry; when the queue is not empty, the method node in the queue is acquired, if a taint source of the node method is non-empty, it indicates that a key module is found, and all subsequent nodes all are method nodes in the key module; if the taint source of the node method is empty, all sub-nodes thereof are acquired and the sub-nodes are added into a queue of the nodes to be analyzed; and finally, when the set is empty, the algorithm is ended.

### 3.2 Program Structure

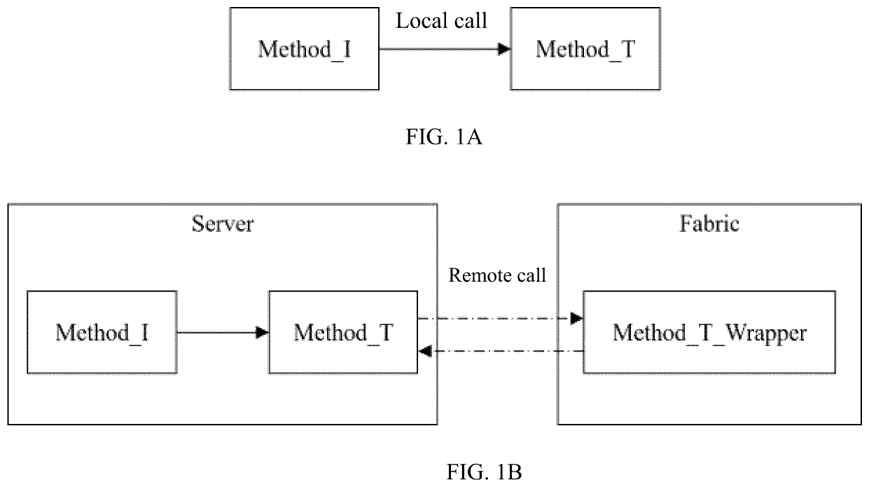

Referring to FIGS. 1A-1B, structures and calling processes of a native application and a target application are described first.

A core of a target program structure includes two elements: a method wrapper Method_T_Wrapper and a method proxy Method_T_Proxy, where an operating principle of the target program structure is as follows:
(1) direct call of Method_T by Method_I is converted into indirect call via the Method_T_Proxy;
(2) the Method_T_Wrapper completes the function as same as the Method_T, is responsible for executing true computation, transforms the Method_T, finds out external variable references thereof, and transforms the method into a form being introduced through parameters and returned through returned values, and the modified class method is stateless; and
(3) the Method_T_Proxy is a proxy of the method Method_T, and external behaviors thereof are consistent with those of the Method_T, and the proxy does not perform actual computation, is responsible for determining an execution position of the method, and perform controlled forwarding (remote call) and data synchronism (including: initializing and serializing the actual parameter data needed to execute the method wrapper, and deserializing the returned values of the method wrapper to update corresponding local variables).

### 3.3 Method Wrapper

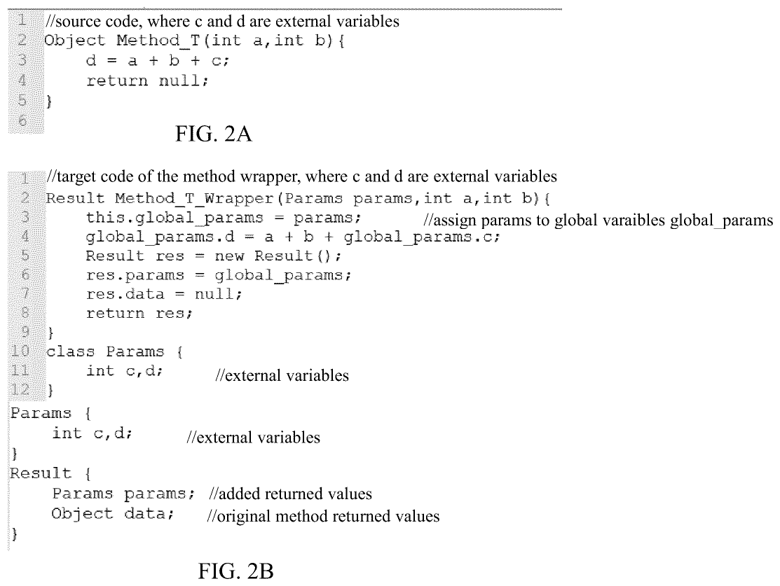

The method wrapper is generated by the following steps:
(1) A parameter list and returned values of the method are modified. As shown in FIG. 2A and the 2nd line of FIG. 2B, the parameters params are increased, representing the external variables of the original method, where the external variables are introduced into a method body in a form of parameters; the statements increased to assign the parameters params to global variables global_params, where all methods in the key module are capable to call external variables of the methods; and moreover, the global_params are added into a returned result, and are capable to return a change condition of the external variables to a method caller; moreover, the global_params are added into the returned result, where the change condition of the external variables can be returned to the method caller;
(2) all statements access to the external variables in the method are modified, as shown in the line 3 of FIG. 2A and the line 6 of FIG. 2B, the external variable references c and d are replaced with corresponding input parameters global_params.c and global_params.d, where there are no statements access to the external variables in the method; and
(3) all return statements of the method are modified, as shown in the line 4 of FIG. 2A and the lines 7-10 of FIG. 2B, the parameters global_params are added into the returned result, where the change condition of the external variables can be returned to the method caller.

### 3.4 Method Proxy

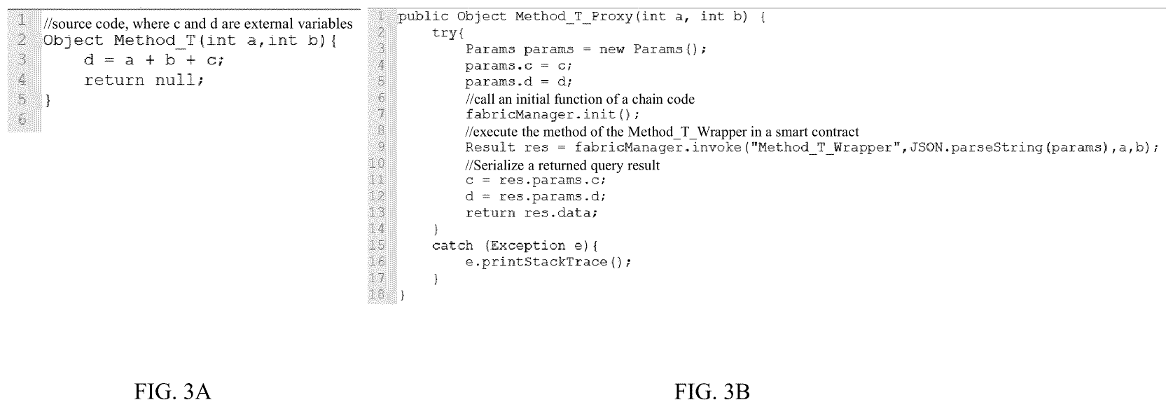

A construction rule for the method proxy is as follows:
(1) a method signature (name and parameter list) and a return type of the method proxy are kept consistent with those of the original method;
(2) statements are increased for processing extra variables; a variable params of a Params type is constructed, and the params are assigned with external variable information of the method;
(3) statements are increased to call the method wrapper in a fabric chain code; in a Hyperledger Fabric, a Java application can use Fabric-Sdk-Java to achieve access to the chain code, the method wrapper in the chinacode is called through a fabricManager object provided by sdk, and moreover, call parameters of the method wrapper are sent; and
(4) the returned results called are increased by a statement receiving method, where the external variables of the method are updated by using result data to guarantee the consistency of the program state, as shown in lines 11-12 in FIGS. 3A-3B; Moreover, a method call returned value is returned to the caller thereof, as shown in line 13 in FIGS. 3A-3B.

### 3.5 JDBC Refactoring

The application program usually uses a relationship database, a relationship table structure needs to be defined first for use of the application program, and then related business codes of the application program edited through JDBC API. A database operating node is an SQL statement in the node, a function of the database is operated through the JDBC API, and the statement is usually a landing point or a start point of the key data in the propagation path.

Because most databases of blockchain use key value databases and do not support SQL operation, the JDBC API is needed to be converted into a key value of a corresponding blockchain to operate API for the database in refactoring, where a current mainstream open source blockchain architecture Fabric chaincode is targeted.

The Fabric chaincode uses a Couch DB key value database, and a refactoring method includes analysis and verification of the SQL statement and operational conversion from the SQL statement to CouchDB.

### Experimental Evaluation

To verify validness and feasibility of the method, the method herein is experimentally evaluated. 10 web open source applications are collected from github and a joint development

| Tool name | Edition number | Description |
|---|---|---|
| hyperledger fabric | 2.2.5 | Hyperledger |
| docker | 20.10.20 | Containerized management |
| | | tool |
| docker-compose | 1.24.1 | Containerized deployment |
| | | tool |
| java | 1.8.0 | Programming language |

Application performance comparison: by comparing the blockchain application reconstructed by the method with the blockchain application developed by a professional in performance, the read-write performance of the application is mainly evaluated. An Apache organizes a pressure test tool Apache JMeter developed based on Java to test the pressure of the Web application, and a test index is transactions per second (tps). Two solutions of each system are subjected to 10-time pressure tests, and a mean value is taken. An experimental result shows that the performance loss is within 8% while the development efficiency of the blockchain application is improved when the blockchain application is developed by using the framework.

| | Native solution | The method | |
|---|---|---|---|
| Ideal crowdfunding system | 39.6 | 37.0 | 6.57% |
| Lottery system | 41.4 | 38.5 | 7.00% |
| Electronic invoice | 53.2 | 50.1 | 5.82% |
| cloud platform | | | |
| Agricultural product | 52.2 | 48.9 | 6.32% |
| traceability system | | | |
| Electronic certificate | 50.4 | 47.5 | 5.75% |
| Electronic medical system | 53.8 | 49.2 | 8.92% |
| Food traceability system | 51.9 | 48.9 | 5.78% |
| Second-hand car trading system | 40.0 | 36.7 | 8.35% |
| House renting system | 40.8 | 38.6 | 5.39% |
| Drug tracing | 53.9 | 49.5 | 8.16% |

What is claimed is:

1. An application migration method from a client-server architecture to a blockchain architecture, comprising the following steps:
S1: modeling an application program of a conventional client-server architecture and abstracting the application program to a program call tree;
S2: defining a taint propagation rule for taint analysis by taking key data as tainted data, to acquire all taint variables in the application program; and
S3: identifying a key module of the application program on the program call tree according to a tainted path, and setting a code refactoring rule to perform code refactoring on a method in the key module according to a special program structure.

2. The application migration method from the client-server architecture to the blockchain architecture according to claim 1, wherein the S1 comprises: establishing the program call tree, constructing the program call tree of the application program from a main function through static code analysis, and marking the key data on the program call tree; and definitions of the program call tree are as follows:
definition 1: a program structure of the application program of the client-server architecture is represented as a program call tree Treeᵣ=(M, R, K), wherein M={m₁, m₂, . . . , mₙ} represents a node set of the program call tree; R represents a node call relationship set, any one rₘᵢ₋ₘⱼ∈R represents a side of the program call tree, representing that a method mᵢ calls a method mⱼ and K={keydata₁, keydata₂, . . . , keydataₙ} represents a key data set in a system;
definition 2: a method node of the program call tree comprises a unique identifier and a call path of the method, a statement set of the method and a set of the key data in the method, and mᵢ=<mSignᵢ, mPath, Uᵢ, kset> is represented by a quaternion, wherein mSign represents the unique identifier of the method mᵢ, mPath represents a method call path from the main function to mᵢ, kset is configured to record all key data in the method mᵢ, and Uᵢ, represents the statement set of the method mᵢ;
definition 3: mSignᵢ={mSig|mName,mParams,returnParams} represents the unique identifier of the method node of the program call tree, wherein mName represents a method name, mParams represents an entry parameter list of the method, and returnParams represents return parameters of the method;
definition 4: mPath={mSigₘₐᵢₙ,mSigₐ, . . . , mSigᵢ} represents the call path of the program call tree method mᵢ, a combination of the unique identifiers of the method node from mₘₐᵢₙ to mᵢ, uniquely forming a path accessible to mᵢ;
definition 5: Uᵢ, ={uᵢ¹, uᵢ², . . . , uᵢⁿ} represents the statement set of the method node mᵢ on the program call tree, wherein uᵢ^{j} represents j^{th} statement of the method mᵢ; and
definition 6: the key data of the system comprises the unique identifier of the key data in the method and a key data name, and eydataᵢ={mSignᵢ, kname} is represented by a two-tuple, wherein kname represents a variable in the method mᵢ with a name of kname, and variables on a data flow branch where all key data is located are allowed to be key variables.

3. The application migration method from the client-server architecture to the blockchain architecture according to claim 2, wherein an algorithm extracted by the program call tree constructs a program call tree of an application program taking mₘₐᵢₙ as a root by taking the main function mₘₐᵢₙ as an entry point of the application program, a HashMap is configured to record a R, a storage form of key is <mᵢ, mⱼ>, formula represents that mᵢ calls mⱼ and a value corresponding thereto represents a number of times when mᵢ calls mⱼ;
for the entry point mₘₐᵢₙ of an input program of the algorithm and the statement set Uₘₐᵢₙ of mₘₐᵢₙ, any uₘₐᵢₙⁱ∈Uₘₐᵢₙ represents an i^{th} statement of Uₘₐᵢₙ;
the program call tree is constructed recursively by calling a method getTree( ), wherein parameters mₐ and Uₐ are written into the method, respectively representing a method to be analyzed and the statement set of the method;
wherein a Soot key word of uₐⁱ is acquired, comprising an intermediate code defined in Soot; a set M is updated to record that a method mₐ calls a method mₛ; a set R is updated to record a method call relationship and update a weight; the method mₛ is subjected to getTree( ) recursion; and when a recursion process is ended, the algorithm outputs the program call tree.

4. The application migration method from the client-server architecture to the blockchain architecture according to claim 1, wherein an assignment statement rule and an alias statement rule in the taint propagation rule in the S2 summarize various ways of a taint variables propagation in the method;
a method call statement rule, a method return statement rule and a method declaration statement rule describe cross-method propagation modes of the taint variables;
for each method node containing the key data, each statement in the method is analyzed according to the taint propagation rule, and when the statement meets any taint propagation rule, it is indicated that a new taint source is found, and the new taint source is added into a taint source set for recording;
wherein when the statement meets the method call statement rule, the method return statement rule or the method declaration statement rule, it is indicated that a new method node to be analyzed is generated, and the method node needs to be added into a set of the method node to be analyzed for recording;
after a round of analysis of all statements of the method is ended, if the new taint source is added into the taint source set, a new round of iteration is started to analyze the method; and
the set of the method node to be analyzed is traversed to analyze each method node in the set one by one.

5. The application migration method from the client-server architecture to the blockchain architecture according to claim 1, wherein the S3 comprises key module identification, program structure and method wrapper generation, method proxy construction, and Java Data Base Connectivity (JDBC) refactoring.

6. The application migration method from the client-server architecture to the blockchain architecture according to claim 5, wherein the step of the key module identification comprises: when a kset set of a method node m_{cur} is non-empty and a kset set of a father method node thereof is empty, taking a sub-tree with m_{cur} as a root node as a key code module of the application program, wherein the key code module is defined as follows:
definition 7: the key code module of the application program is represented as Module=(module₁, module₂ . . . moduleₙ), Module∈ Treeᵣ, wherein moduleᵢ is a sub-tree of Treeₘₐᵢₙ, representing a key code mode of the application program and being represented as moduleᵢ=<M,R>(if i≠j, moduleᵢ∩moduleⱼ=Ø);
identifying the key module: adding the root node mₐ into a queue of the method node to be analyzed by taking the program call tree as an input and the root node mₐ of the program call tree as an entry;
when the queue is not empty, acquiring the method node in the queue, if a taint source of a node method is non-empty, indicating that the key module is found, and all subsequent nodes all are method nodes in the key module;
if the taint source of the node method is empty, acquiring all sub-nodes thereof and adding the sub-nodes into a queue of the nodes to be analyzed; and
when the set is empty, ending an algorithm.

7. The application migration method from the client-server architecture to the blockchain architecture according to claim 5, wherein structures and calling processes of a native application program and a target application program are described first;
a core of a target program structure comprises two elements: a method wrapper Method_T_Wrapper and a method proxy Method_T_Proxy, wherein an operating principle of the target program structure is as follows: direct call of Method_T by Method_I is converted into indirect call via the Method_T_Proxy;
the Method_T_Wrapper completes a function as same as the Method_T, is responsible for executing true computation, transforms the Method_T, finds out external variable references thereof, and transforms the method into a form being introduced through parameters and returned through returned values, and a modified class method is stateless; and
the Method_T_Proxy is a proxy of the method Method_T, and external behaviors thereof are consistent with external behaviors of the Method_T, and the proxy does not perform actual computation, is responsible for determining an execution position of the method, and perform controlled forwarding and data synchronism.

8. The application migration method from the client-server architecture to the blockchain architecture according to claim 5, wherein a method wrapper is generated by the following steps:
1) modifying a parameter list and returned values of the method; increasing parameters params, representing external variables of an original method, wherein the external variables are introduced into a method body in a form of parameters; increasing the statements to assign the parameters params to global variables global_params, wherein all methods in the key module are allowed to call the external variables of the methods; and adding the global_params into a returned result, and being allowed to return a change condition of the external variables to a method caller;
2) modifying all statements access to the external variables in the method, replacing external variable references c and d with corresponding input parameters global_params.c and global_params.d, wherein there are no statements access to the external variables in the method; and
3) modifying all return statements of the method, adding the parameters global_params into the returned result, wherein the change condition of the external variables is allowed to be returned to the method caller.

9. The application migration method from the client-server architecture to the blockchain architecture according to claim 5, wherein a construction rule for a method proxy is as follows:
1) keeping a method signature and a return type of the method proxy consistent with a method signature and a return type of the original method;
2) increasing statements for processing extra variables; constructing a variable params of a Params type, and assigning the params with external variable information of the method;
3) increasing the statements to call a method wrapper in a fabric chain code; in a Hyperledger Fabric, calling the method wrapper Method_T_Wrapper in the chain code through a fabricManager object provided by sdk, and sending call parameters of the method wrapper; and
4) increasing returned results called by a statement receiving method, wherein external variables of the method are updated by using result data to guarantee a consistency of a program state, and returning a method call returned value to a caller thereof.

10. The application migration method from the client-server architecture to the blockchain architecture according to claim 5, wherein the application program for JDBC refactoring uses a relationship database, a relationship table structure needs to be defined first for use of the application program, and related business codes of the application program edited through JDBC API;
a database operating node is an SQL statement in a node, a function of the relationship database is operated through the JDBC API, and the statement is a landing point or a start point of the key data in a propagation path;
the JDBC API is converted into a key value of a corresponding blockchain to operate API for the relationship database, wherein a current mainstream open source blockchain architecture Fabric chaincode is targeted; and
the Fabric chaincode configures a Couch DB key value database, and a refactoring method comprises analysis and verification of the SQL statement and operational conversion from the SQL statement to the Couch DB.
